(19) United States
(12) Patent Application Publication
(10) Pub. No.: US 2003/0180703 A1
(43) Pub. Date: Sep. 25, 2003

(54) Student assessment system

(75) Inventors: Daniel Yates, San Francisco, CA (US); Jay Kimmelman, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Edusoft, San Francisco, CA

(21) Appl. No.: 10/353,814

(22) Filed: Jan. 28, 2003

Related U.S. Application Data
(60) Provisional application No. 60/352,784, filed on Jan. 28, 2002.

(51) Int. Cl. G09B 7/00

(52) U.S. Cl. 434/353

(57) ABSTRACT

Systems and methods for providing educational assessment of at least one student using a computer network. The computer network includes a central server and at least one remote terminal, including a image scanner. The method includes providing a test for subject matter and dynamically generating an answer sheet for the test. A completed answer sheet is scanned with the image scanner. Answers are graded on the scanned image of the answer sheet and results are automatically stored from the grading of the answer sheet in a central repository at the central server for the at least one student. Various evaluations and assessments may be made using the results with student information and demographics.

### CROSS-REFERENCES TO RELATED APPLICATIONS

This application claims priority to U.S. Provisional Application No.60/352,784 filed Jan. 28, 2002 which is herein incorporated by reference for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

1. Field of the Invention

The present invention is directed to systems and methods for allowing educators to assess student performance, and more particularly, to systems and methods for creating, delivering and automatically grading student assessments, storing the results in a data warehouse, and enabling educators to use data analysis and tracking tools, and generate instructional materials and reports.

2. Description of the Prior Art

Educators are constantly attempting to assess student performance. This is especially important for determining students' progress and for determining how to help the student learn more and progress more satisfactorily.

Standardized tests have long been used in order to gauge students' progress. Unfortunately, the information provided by traditional standardized tests is limited. Additionally, one must generally wait long periods of time for the results to be obtained. Furthermore, the information provided is very limited and often does not allow educators to use results based upon various demographics. Also, the results may not provide enough detailed information with regard to various subjects the students need further work in.

Accordingly, there is a need for an assessment system that allows educators to use data analysis and tracking tools in assessing students' progress in various subject matter and in generating materials for helping the student make the desired progress.

### BRIEF SUMMARY OF THE INVENTION

The present invention provides a method of providing educational assessment of at least one student using a computer network. The computer network includes a central server and at least one remote terminal, including a scanner. The method includes providing a test for subject matter and providing an answer sheet for the test. A completed answer sheet is scanned with an image scanner. Answers are graded on the scanned image of the answer sheet and results are automatically stored from the grading of the answer sheet in a central repository at the central server for the at least one student.

In accordance with one aspect of the present invention, the answer sheet is automatically flipped if the scanned image of the answer sheet is upside down.

In accordance with another aspect of the present invention, the answer sheet uniquely identifies the particular test and the group of students who are taking the test. In some instances of the invention, the answer sheet contains both an identification icon that identifies the group of students, and a list of all students in the group with a fill-in icon by each student's name. The combination of the identification icon and filled-in icon by student's name provides all information for obtaining required information from a central repository at central server to identify the student taking the test. Additionally, the combination may include all the information necessary for grading the answer sheet.

The present invention also provides a method of generating an assessment providing curricular categories to be assessed, automatically obtaining questions and answers related to the curricular categories from a central repository at the central server based upon past performance of the at least one student within the curricular categories, providing an interface to manually select additional questions and answers, automatically generating a test with the questions and answers, and automatically generating an answer platform.

The present invention also provides a method of providing educational assessment of at least one student using a computer network that includes a central server and at least one remote terminal where the method includes providing the central repository contains performance data from prior assessments organized by curricular categories for the at least one student, providing a selection of curricular categories, providing the number of curricular categories to review, providing the number of questions and answers per curricular category to assign, generating an individualized homework assignment for each of the students comprising questions from prior tests in the central repository that the student missed in the curricular categories for which they performed the most poorly, additional questions in each of the curricular categories randomly drawn from the central repository that, when added to the number of questions missed from prior tests total the number of questions assigned per curricular category, and instructional resources categorized to the curricular categories for which the student performed the most poorly.

The present invention also provides a system for providing educational assessment of at least one student where the system includes a central server including a central repository, the central repository including student information from a school district student information system and a plurality of questions and corresponding answers for a variety of subject matters, the questions and answers being organized based upon at least subjects within the subject matters. The system also includes at least one remote terminal, the remote terminal being coupled with the central server via a communication conduit; at least one remote scanner in communication within the remote terminal, wherein tests and corresponding answer platforms are automatically generated by the central server based upon the student information and desired subject matter.

The novel features which are characteristic of the present invention, as to organization and method of operation, together with further objects and advantages thereof will be better understood from the following description considered in connection with the accompanying drawings in which a preferred embodiment of the invention is illustrated by way of example. It is to be expressly understood, however, that the drawings are for the purpose of illustration and description only and are not intended as a definition of the limits of the invention.

### BRIEF DESCRIPTION OF THE DRAWINGS

FIG. 1 is a schematic illustration of a system in accordance with the present invention;

FIG. 2 is a flowchart illustrating an overall assessment process in accordance with the present invention;

FIG. 3 is a flowchart illustrating a scanning and grading process in accordance with the present invention;

FIG. 4 illustrates an example of an answer sheet in accordance with the present invention;

FIGS. 5A-C illustrate an example of a test and answer key in accordance with the present invention; and

FIGS. 6A-C illustrate an example of a homework assignment and answer key in accordance with the present invention.

### DETAILED DESCRIPTION OF THE INVENTION

The present invention will be described in greater detail as follows. First, a number of definitions useful to understanding the present invention are presented. Next, the hardware and software architecture of the system is presented in the System Overview. Finally, a series of sections describe the various services provided by different embodiments of the present invention.

Definitions

Curricular Category A curricular category is any collection of curriculum belonging to one topic or sub-topic. For example, within the study of mathematics, all curricular material related to adding or subtracting fractions may be organized in one curricular category. Categories may be arranged hierarchically as well. For example, a curricular category might include all operations on fractions, while sub-categories might include adding fractions, subtracting fractions, and dividing fractions.

Scanner A scanner is any of a number of devices that is able to create an electronic image from a piece of paper. Scanners could include additional features such as automatic document feeders to take in several pages at once.

Instructional Materials Educational information that may be used in the process of educators instructing students, and that may be stored electronically or pointed to electronically. For example, test questions, lesson plans, sections of a textbook, problems in a textbook, professional development videos for teachers, homework, and review materials.

Data warehouse An electronic collection of data that may be queried. For example, a relational database, a hierarchical file system, or a combination of the two.

System Overview

The present invention includes software running on one or more servers —computers that are accessible over an internet protocol (IP) network—and one or more local computers which communicate with the servers. Those skilled in the art will understand that other communication or network protocols and systems may be used. Educators use the system via a Web interface 20, and in some instances of the present invention, through custom software on the client computer. When accessing the web interface, an educator's Web browser 20 displays pages generated from the servers and accessed via the HTTP or HTTPS protocol. These Web pages typically contain user-interface elements and information in the Internet standard HTML format, or printable reports in an industry-standard Portable Document Format (PDF) format. While HTTP, HTTPS, and HTML are industry standard formats and preferred elements of the present invention, the PDF format is simply one of many formats that could be used for printable reports. When accessing the system through custom software, educators run the software on their computer, and the software communicates with the servers through HTTP or HTTPS protocol.

The system provides a user interface that allows educators to create new tests (using a databank of test questions and their own questions), to create paper or online answer sheets for existing tests, to automatically grade tests, to generate detailed reports from test results, and to automatically generate additional instructional material such as homework problems or review sheets based on test results.

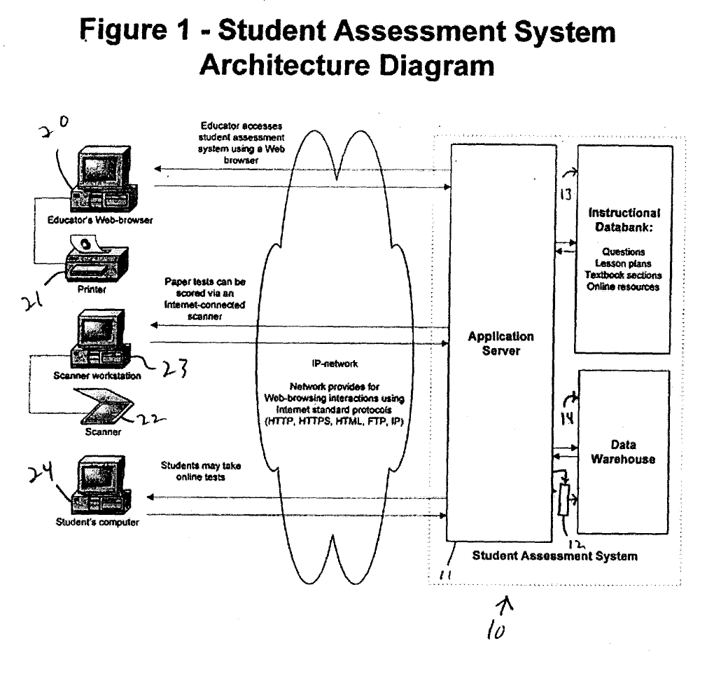

As may be seen in FIG. 1, the Assessment System server(s) 10 preferably includes four components: an Application Server 11, a Grading Server 12, an Instructional Databank 13, and a Data Warehouse 14. The Application Server generates HTML pages accessible via the HTTP protocol. It is the point of contact for the Web browsers used by all users of the system. The Grading Server scores student responses to tests taken through the system whether online or offline. The Instructional Databank stores instructional material organized by curricular category, for example test questions, lesson plans, textbook sections, or online resources. The Data Warehouse stores student or educator roster information as well as student test scores. The roster information in the Data Warehouse specifies what school, classroom(s), and class(es) each student is enrolled in, as well as what school, classroom, and classes each educator is responsible for. The student test scores in the Data Warehouse identify individual student performance on specific test questions, tagged with the particular curricular category tested by each question.

In some instances of the present invention, educators may use the system to create paper tests, answer sheets, reports, review sheets, homework assignments, progress reports, and other reports. In these instances, printers 21 are additional components of the system. An Educator accessing the system may print any Web page generated by the servers, whether it is in the HTML format, Adobe PDF format, or other format.

In some instances of the present invention, educators may use the system to electronically save paper curricular material, or to automatically grade paper tests. In these instances, scanners are additional components of the system. When creating new test questions, educators may use an image scanner 22 to make an electronic copy of a question from a paper test. When grading paper tests, the scanners are used to scan the answer sheets used by students and submit either the images from the scanned documents or the graded results of the answer sheets back to a central server. A scanner must be connected to the central server via IP—the scanner may either be directly connected to the Internet, or it may be connected to another computer 23 (a scanner workstation) that is connected to the central server.

In some instances of the present invention, a student may take a test using a computer connected to the central Assessment System. In these instances, the student uses a computer 24 that connects to the central server(s) using IP. The student may also interface to this system using HTML pages generated by servers and delivered via HTTP.

Creation of new assessments

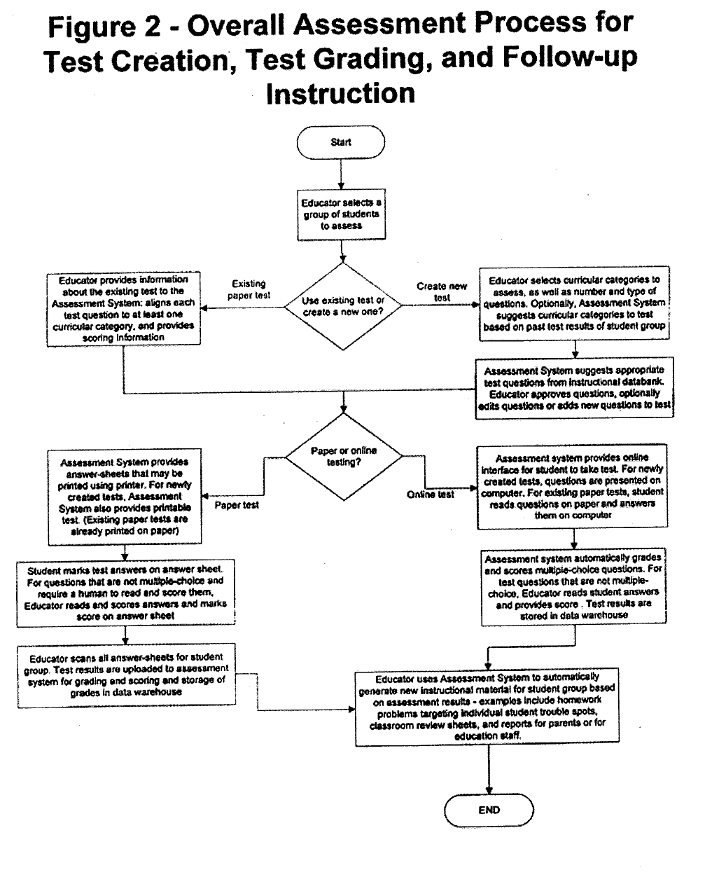

With reference to FIG. 2, when an educator creates a new assessment, the Assessment System must know the group of students whose performance is to be tested. This selection may happen manually (the educator specifies a group of students by choosing among a list of students or a list of classes). The selection may also happen automatically (the system identifies the students that are associated with that particular educator, for example, a 3^{rd} grade teacher who teaches a classroom of 20 students).

Once the system knows the group of students to be tested, the educator must select the curricular categories for the assessment, as well as the number and type of questions. For example, a 3^{rd} grade teacher may choose to assess his students' performance in math, specifically addition and subtraction, and he may choose to have 10 multiple choice questions and 10 short-answer questions. If the Student Assessment System has records of past test performance for the group of students to be tested, the system may optionally recommend additional curricular categories to “re-test”, allowing an educator to re-assess student performance in particular areas of past weakness. Additionally, the system may recommend to the educator specific questions that students had difficulty with on past exams, and the educator may select to add those questions to the test, or modify them so as to test a similar, but new, question.

Now that the system knows the group of students to be tested, the relevant curricular categories to be assessed, and the number and type of questions for the assessment, the system draws on the Instructional Databank to pick appropriate test questions matching the curricular categories. These questions are presented to the educator, and the Assessment System may provide the educator with an interface to approve questions or optionally to edit, add, or remove questions. In particular, the system may allow an educator to use a scanner to scan paper questions and “upload” the questions to the Instructional Databank, thus allowing the educator to add new questions to the assessment. The system may also enable the educator to use question creation tools on the website to create their own questions electronically, and add those questions into the test being created.

Assessment questions may be multiple choice questions with 2 or more possible answers, allowing for true/false questions as well as questions where a student must choose one of many possible answers. Questions may also be in “short answer” format, where there is a single right or wrong answer for a question, for example “what is 2+2?”. These questions are graded as being completely correct or incorrect, with no partial credit. Lastly, questions may be in “long answer” or “essay” format, where a student must provide a longer answer that may be graded with partial credit (e.g. 4 out of 5 points). Some examples:

Multiple choice: What is 2+2? (a) 1 (b) 2 (c) 3 (d) 4

Short answer: What is the capital of the United States?

Long answer: Explain the reasons for the American Revolution

Once the educator has modified, removed, added, and approved the test questions, the new assessment is ready to be delivered to the group of students.

Re-use of existing assessments

An existing assessment created in the manner above may easily be re-used by any educator—the Student Assessment System maintains all student groups and student assessments in the data warehouse. Educators may share their assessments with other teachers for usage with their classes. In addition, an educator may want to use an existing assessment that is in paper format. In such cases, an educator will have a paper copy of an assessment, and he needs to provide enough information to the Assessment System to allow the system to automatically grade and analyze student performance on the assessment.

In order for the Assessment System to take advantage of existing paper assessments, the educator must provide information to the Assessment System specifying exactly how many questions are included in the paper assessment, aligning each question to one or more curricular categories, and providing scoring information. Because of the process of aligning each question to one or more curricular categories, this process is called “Align a test”. For example, an educator may input information to the Student Assessment System specifying that a particular paper test named “3^{rd} Grade Math Test” includes 10 multiple choice questions, the questions are worth 5 points each, the first five questions test the category of addition, the second five questions test the category of subtraction, and the correct answers are a, b, e, d, c, d, d, c, a, and b.

Once the Assessment System knows this information, it may not only automatically grade student assessments, but it may also provide analysis on student performance in different curricular categories.

As is the case with the creation of assessments in the Assessment System, existing tests that are graded and analyzed by the system may include multiple choice, “short answer”, and “long answer/essay” questions.

An educator may also choose to scan and upload digital images of the paper assessment to be used. While this is not necessary if the test is to be delivered to students on paper, it would enable the test questions to be re-used conveniently (and electronically) by other educators, and may also enable the test questions to be delivered to students electronically.

Automatic grading of paper assessments

To deliver paper assessments, an educator needs paper copies of assessments and answer sheets. When re-using an existing paper assessment, an educator will already have the paper copy. With newly created assessments, the educator may print paper copies of the new assessment using a printer device connected to his Web browser. In some instances of the present invention, the new assessments may be formatted in the Adobe PDF format for more accurate printing, but in other instances other printable formats may be used (such as HTML). These paper assessments may be easily photo-copied if they are printed on regular paper.

In addition to the paper copy of the assessment itself, an educator will need paper answer sheets to give to students in the group that is being assessed. The educator may print paper copies of the answer sheets using a printer device connected to his Web browser. Because the Assessment System knows the group of students being tested, it may generate printable answer sheets that are customized to that group or classroom of students. In some instances of the present invention, the answer sheets may be formatted in the Adobe PDF format for more accurate printing, but in other instances other printable formats may be used.

During the test-taking process students will read the paper assessments and provide answers to objective questions on the paper answer sheets. Objective questions include multiple choice, matching, true/false, grid-in answers, etc. Answers for long-answer questions may also be written on separate paper. Afterwards, the educator will need to personally grade and score any subjective questions, marking the correctness of these questions or the number of points received on the printed answer sheets.

Once student-marked objective questions and teacher-marked subjective questions have been filled in on the answer sheet, the sheets are then scanned using a scanner. The system may work with any scanner that creates an electronic image of the answer sheet. One instance of the invention interfaces with a scanner that captures sets of answer sheets as a multi-page TIFF file that is then analyzed for grading.

Scanned answer sheets are then processed through the system, where results are scored and stored in the data warehouse. The process of grading answer sheets includes image processing, accessing assessment and student information in the data warehouse, applying grading rules, and storing results in the data warehouse.

Dynamic Answer Sheets

The answer sheets generated by the Student Assessment System in accordance with the present invention share some similarities with traditional answer sheets used in prior art (for example Scantron or NCS OpScan answer sheets). In particular, human input is provided by making pencil or pen marks in “bubbles” or small circular areas on the answer sheet. These “bubbles” may be detected automatically and a computer may identify whether a particular bubble has been marked as filled or not.

Despite this similarity, there are a number of unique aspects to the answer sheets generated by the Student Assessment System in accordance with the present invention:

Answer sheets are dynamically generated from the website for each assessment, with the exact number and types of questions appearing on the answer sheet for that assessment.

Answer sheets may be printed out on standard 8.5″×11″ paper, and photocopied before use. The system does not require any pre-printed, specialized scanning sheets designed for a particular scanning device.

Because the Assessment System knows the group of students being tested, the answer sheets for that group of students may list the students on the answer sheet, allowing each student to identify his or her assessment by marking in a bubble next to his or her name. In this case, a student does not need to write his or her full name, or use bubbles to identify his or her student ID or full name.

In some instances of the present invention, the answer sheet provides the spaces for the student to bubble in their student ID, rather have their name listed with a bubble next to it.

The system matches up all the demographic data about the student that is stored and categorized in the data warehouse with the student's results on the assessment, so there is no need to “pre-slug” the answer sheet with demographic data. With many other answer sheet technologies, any demographic information which is to be tracked along with the student results on the assessment must be keyed onto the answer sheet, either manually by the student or in advance through an additional process. With the Assessment System, when the student answer sheet is scanned, the results from the test are stored in the data warehouse, and may be cross referenced with all the pre-existing demographics with no additional inputting of data.

In each of the four comers of the answer sheet is a large black square that is generated by the system as a “registration mark”. These marks are used in the image recognition portion of the system to identify and orient the four comers of the answer sheet. In some instances of the present invention, one or more black marks are placed on the answer sheet asymmetrically so that it may be easily detected if the answer sheet is upside down during the scanning and scoring process.

A document ID is placed on the answer sheet. The document ID is unique to each answer sheet, and acts as a key for the system to look up all the information about the assessment and the students taking it. The combination of the student bubble next to their name and the document ID provide all the necessary information for the Assessment System to properly score, categorize and store all of the information about the student's performance on the test. The order in which answer sheets are processed has no effect on each answer sheet, and no header sheets are necessary to correctly identify the answer sheets. In some embodiments of the present invention, the document ID is a 64-bit number that is represented as two rows of 32 black boxes, where the box is black to represent a 1, and blank to represent a 0.

Depending on the given test, the answer sheet may include spaces for multiple choice, “short answer” and “long answer/essay” questions. Multiple choice questions are represented by a series of bubbles, each bubble corresponding to a possible answer for the question. Short answer questions are marked either entirely correct or entirely incorrect. For each short answer question there is a box for the educator to mark whether or not the student should receive credit for their answer. Long answer/essay questions may be created with point values ranging from 1 to 1000 points. Depending on the number of points possible on the question, the answer sheet has differing configurations of bubbles. In one instance of the present invention, there are either one, two, or three rows of 10 bubbles. If the question is worth 9 points or less the answer has a single row of 10 bubbles, labeled with the numbers zero through nine. For questions worth 0 to 100 points, the answer sheet has two rows of ten bubbles. If a student receives a 95 on a question worth 100 points, the educator bubbles in the bubble labeled 90, and the bubble labeled 5.

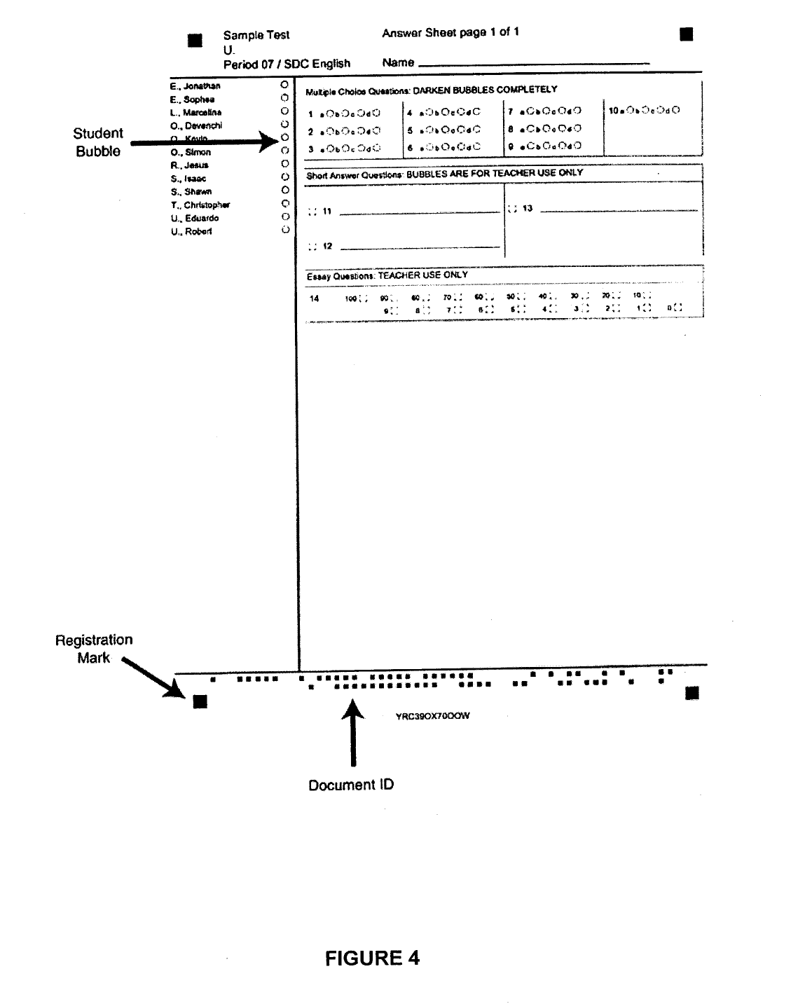

FIG. 4 illustrates an example of an answer sheet in accordance with the present invention.

Scanning of Answer Sheets

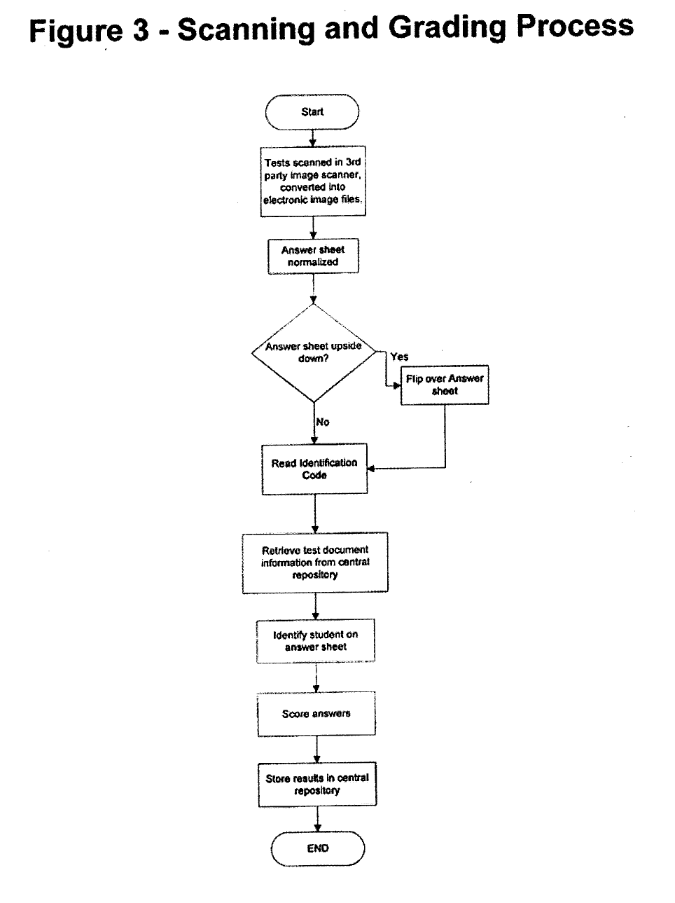

With reference to FIG. 3, scanning of answer sheets is done either through a scanner that is directly connected to the internet, or a scanner that is connected to an internet connected computer. Once the images are scanned, they are either graded locally by the software at the site of the scanning, and the results are transmitted over an IP network to the centralized data warehouse, or the electronic images of the scanned files are transmitted via an IP network to the Application Server, where the images are processed and graded centrally. The system supports any of a number of off-the-shelf scanners that may readily be found at most computer supply stores.

Grading Answer Sheets

In order to properly grade the answer sheet, the system may orient the scanned image and correct any distortions introduced through the scanning of the answer sheet. Image processing of the answer sheets starts by identifying the four large “registration marks” in the corners of the answer sheet (See attached “Example Answer Sheet.) Given the four coordinates of the registration marks, the answer sheet image may be processed so as to orient and normalize the answer sheet. The system first checks an additional set of marks on the page to identify if the answer sheet is upside down. If the answer sheet is upside down, the software inverts the image so that it may process it normally.

In one instance of the present invention, a three dimensional linear transformation is applied to normalize the sheet. In particular, a perspective transform is used for the normalization. The perspective transform maps an arbitrary quadrilateral into another arbitrary quadrilateral, while preserving the straightness of lines. The perspective transform is represented by a 3×3 matrix that transforms homogenous source coordinates (x, y, 1) into destination coordinates (x′, y′, w). To convert back into non-homogenous coordinates, x′ and y′ are divided by w.

$$\begin{matrix}[ \begin{matrix}{x}^{′} \\ {y}^{′} \\ w\end{matrix} ] = [ \begin{matrix}m00 & m01 & m02 \\ m10 & m11 & m12 \\ m20 & m21 & m22\end{matrix} ] [ \begin{matrix}x \\ y \\ 1\end{matrix} ] = [ \begin{matrix}m00x + m01y + m02 \\ m10x + m11y + m12 \\ m20x + m21y + m22\end{matrix} ] \\ {x}^{′} = \frac{m00x + m01y + m02}{m20x + m21y + m22} \\ {y}^{′} = \frac{m10x + m11y + m12}{m20x + m21y + m22}\end{matrix}$$

Once the answer sheet has been normalized, the location of all bubbles on the answer sheet are known, and the software may easily examine each location to determine if it has been darkened.

In one instance of the present invention, a series of black boxes are used to determine if the answer sheet has been scanned in upside down. If the black boxes are not found in the expected location the page is electronically flipped over in the software and checked again.

Given a normalized answer sheet, the system is able to identify the unique document ID on the answer sheet as well as the darkened student bubble, providing enough information to look up all the information about the answer sheet. With this information, the answer sheet will be scored and graded, and the information will be stored in the data warehouse for the particular student who used the given answer sheet.

In the case where the Perspective Transform is used to normalize the document, it is possible that it does not perfectly correct for all distortions of the answer sheet. A spatial locality algorithm is then used to home in on the exact locations of the answer bubbles. Each bubble is checked within a space larger than the width of a bubble, centered at the predicted location of the bubble. The darkest spot the size of a bubble within that space is considered to be the true location of the bubble, and it is at that darkest point where it is determined if the bubble is darker than the specified threshold for darkness.

Storing Scores in the Data Warehouse

Once the answer sheet has been graded, the results are stored in the data warehouse, and automatically linked to any other student performance and demographic data already in the system. In some instances of the system, a roster file is imported into data warehouse from the student information system, enabling the tracking of students by period, teacher, course, school, grade, and other variables. In these instances, if an answer sheet has been graded, and the student is not already in the course or period from where the answer sheet was given, the data warehouse automatically adds the student into the correct place in the roster, and stores the scores.

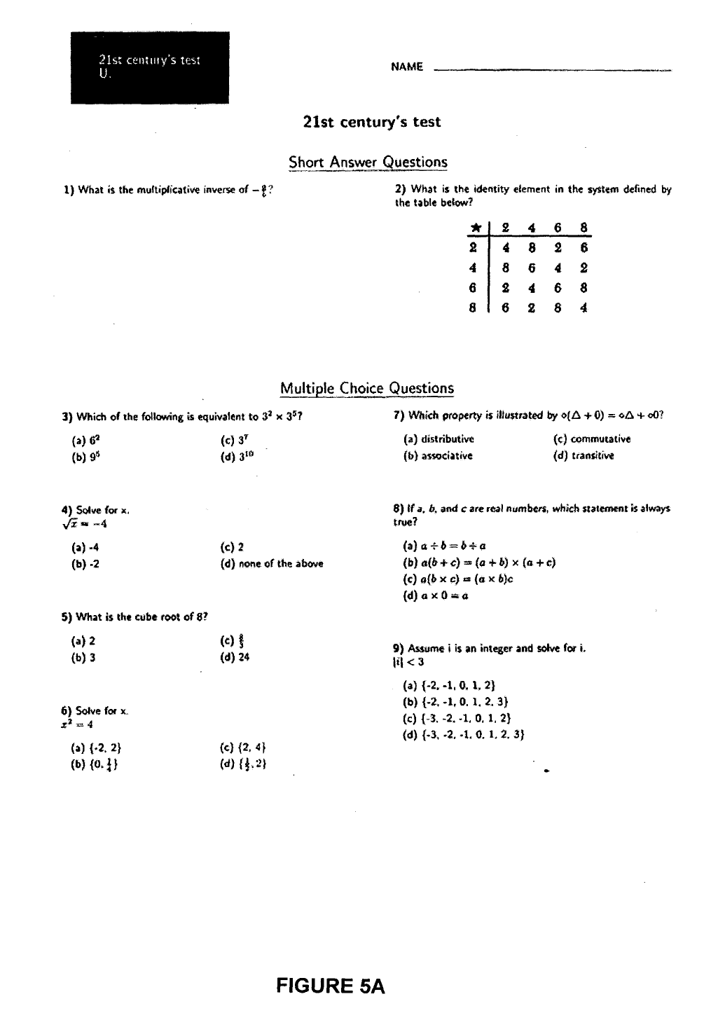

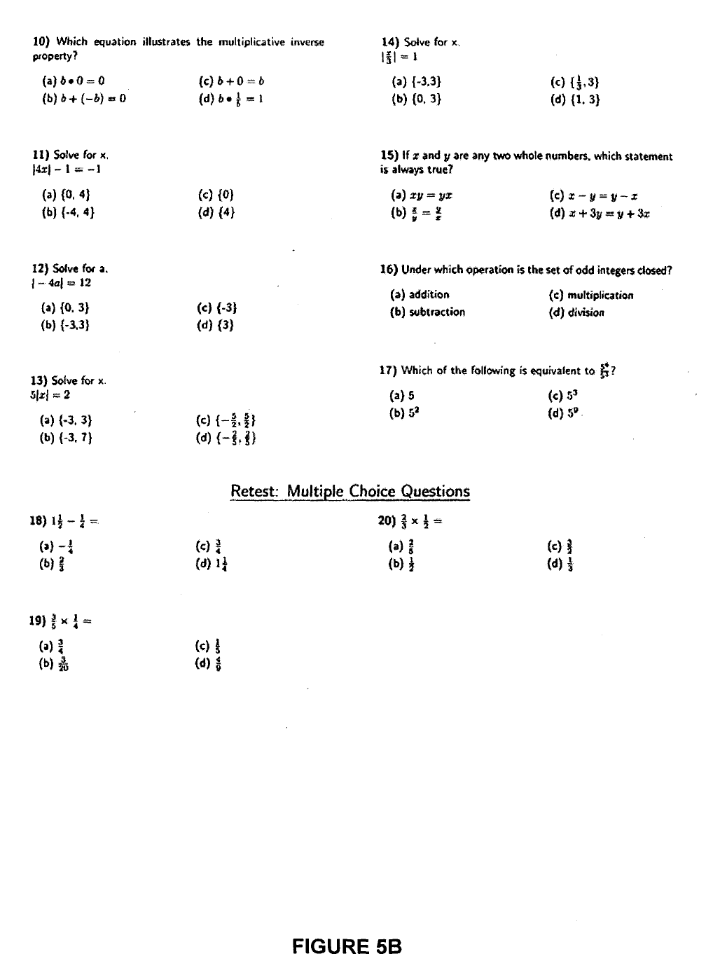

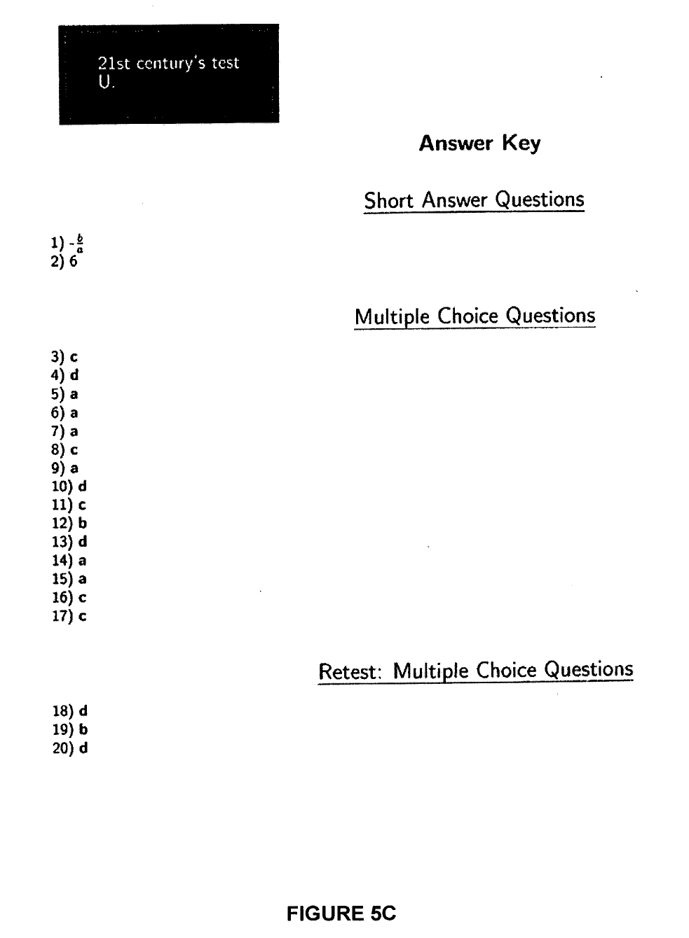

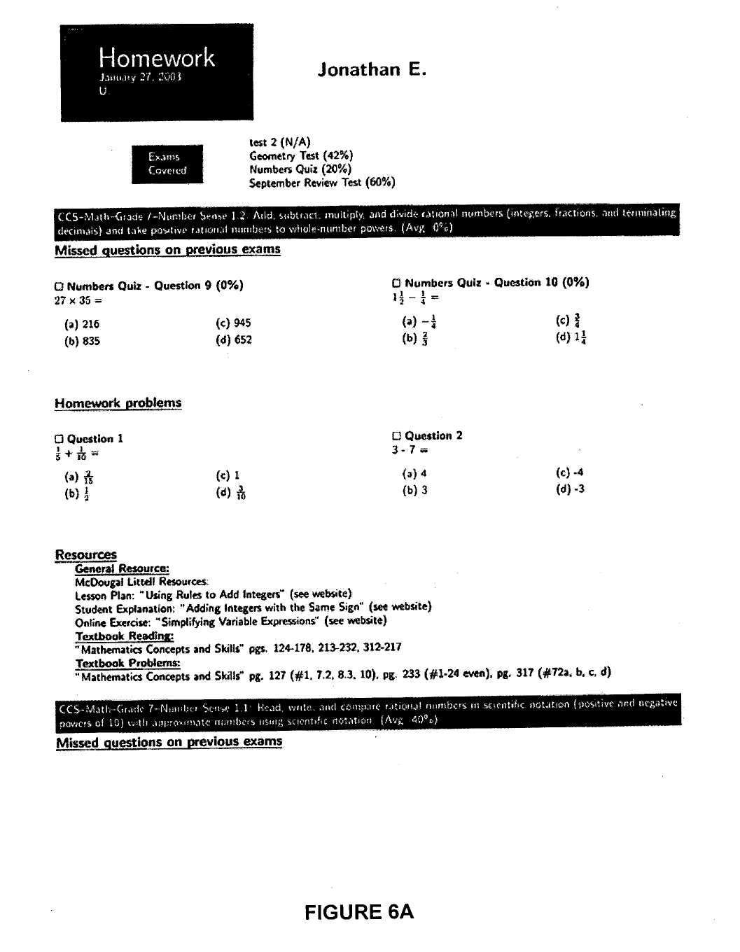

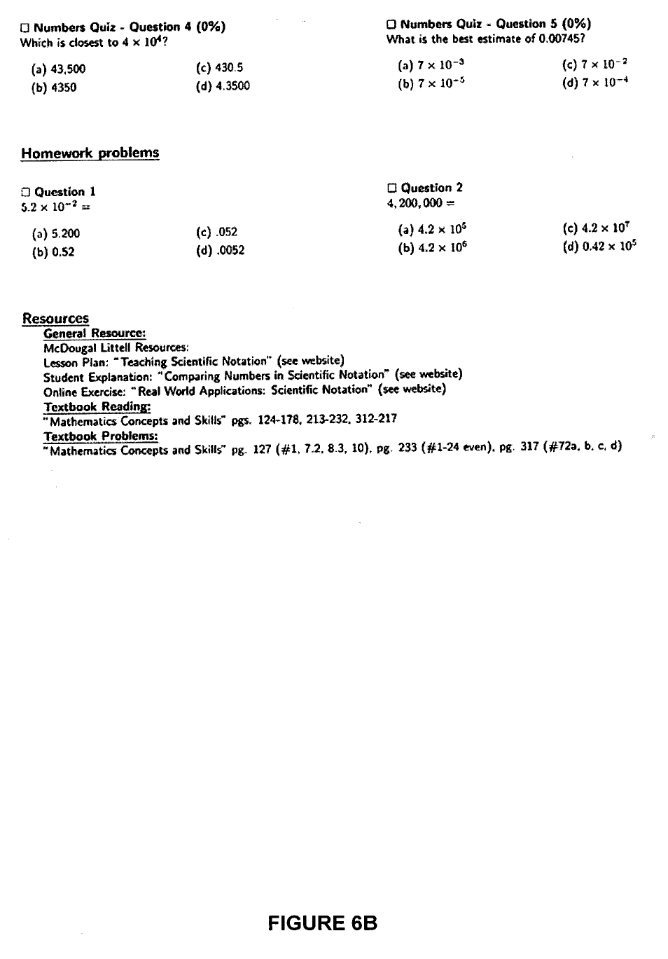

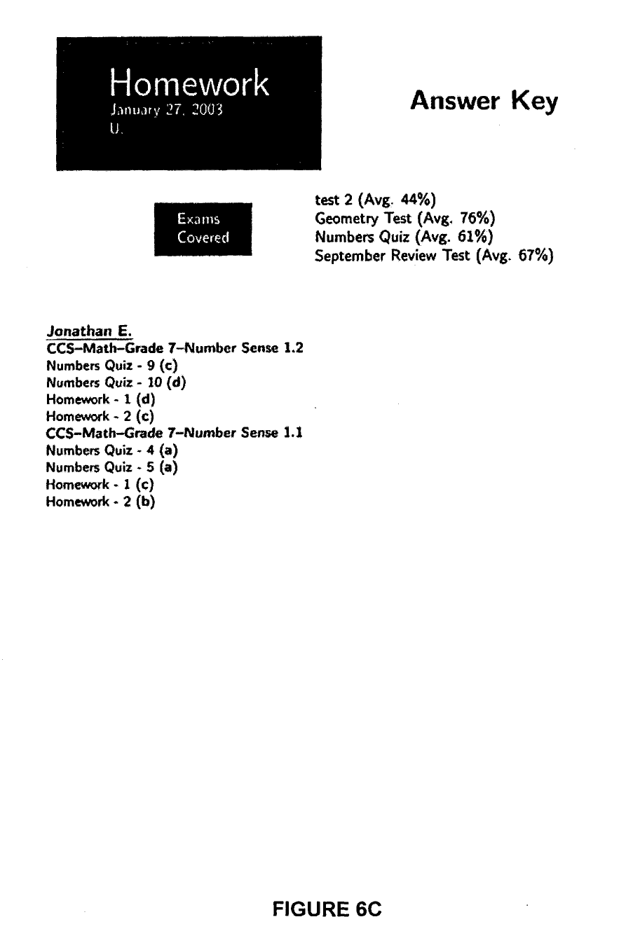

FIGS. 5A-C provide examples of a test and answer key in accordance with the present invention. FIGS. 6A-C provide examples of a homework assignment and answer key in accordance with the present invention.

ANALYSIS AND PERFORMANCE TRACKING

As student data is collected in the system, either through the usage of the Assessment System's automatic grading mechanisms, or through direct import of data into the data warehouse, the Assessment System will provide educators with a variety of analysis and performance tracking tools to better understand and track their students' performance.

The data warehouse may contain the results of student performance on each assessment categorized by curricular category, and additionally contains an assortment of student demographic data, along with other fields of information that may be tagged per student. For example, for a single student the data warehouse may contain results on the state-wide exams, including all the sub-part scores on the test, results on teachers' tests organized by curriculum category, and student ethnicity, gender, socio-economic status, as well as attendance record, discipline record, and historical grade point average.

The Assessment System may enable educators to define sets of criteria by which to group and track students who need special attention. While some prior art store results of student assessments in conjunction with demographic data, they do not provide the functionality to create and track groups of students out of custom defined assessment and demographic criteria. For example, educators may choose to identify all 3^{rd} grade students in Johnson Elementary school who scored less than 30% on last year's state-wide reading assessment and this year's district-wide reading assessment as their “Johnson Early Readers”, and work with those students to improve their reading. Given that set of criteria, the Assessment System may generate the list of the students who meet the criteria, and enable the educators to save the student group as “Johnson Early Readers” for future tracking. In this way, the educators may track the performance of students on whom they focus their educational efforts. In this example, at the end of the year the educators at Johnson elementary may look at how their “Johnson Early Readers” did on this year's state-wide exam, and easily compare that performance to last year's results to see if their efforts resulted in an improvement.

Once a group of students has been defined and saved for tracking, that group may itself be used as a demographic criteria for identification, enabling an iterative system to evolve. Students may be tracked based upon their membership in combinations of groups, and these combinations may then be used to generate new group memberships through the performance of set operations on the groups. For example, new groups may be formed through unions and intersections of previously existing groups, and students may be manually added to groups. In this way, student groups for tracking may be modified as new data arrive in the data warehouse.

In addition to the student performance and demographic data, a third type of data may be stored in the warehouse: configurable performance bands per assessment. Performance bands may be set per curricular category, or for the assessment overall, and students may then be grouped according to which band their score falls into. For example, a given assessment worth 90 points could have 3 performance bands associated with it: Below Average (0-30), Average (31-60), Above Average (61-90). Additionally, if 45 points on the assessment tested the curricular category of addition, and the remaining 45 points tested subtraction, the assessment could also have a set of performance bands for those two curricular categories. For example: At Risk (0-30), Mastery (31-45). Educators have control over the definition performance bands, enabling them to set the bands to be most appropriate for their student body, as well as for the requirements of their district and state. For example, teachers with under performing students, such as special education students, may set their performance bands to be lower ranges than teachers with high performing students. With these performance bands defined, educators may use them for their analyses. In particular, they may choose to view students who fall into a particular performance band, view the percentage of students within each band, or view the average band of performance for a group of students. Additionally, they may include this performance band analysis in any of their reports.

The Assessment System may provide educators with access, through a set of tools, to all the assessment scores, demographic variables per student, and performance band information. Tools are provided to educators for investigative and reporting purposes, enabling them to readily identify areas of need, and then to print readable reports for distribution to students, parents, and other educators. Results may be reported on both aggregated or disaggregated student groups, giving educators full control to access the results of the students and the curriculum topics that interest them. As an example, an 11^{th} th grade teacher could look at the disaggregated results of the Hispanic, male students in their 3^{rd} period Algebra II class on the most recent assessment, broken down by curricular category and sorted by performance. Similarly, a district administrator could access the results of the entire district on the state-wide math assessment aggregated by grade and listed for the past four years of testing. These results may be viewed either as HTML, PDF, or other printable formats.

In some embodiments of the present invention there is a Grade Book tool for teachers, enabling them to view their student scores within the semester sorted by performance and broken down by curricular category. Teachers may select an individual student or an individual tests to “drill-down” and see the performance information about that single test or student. Additionally, some embodiments of the present invention provide a Progress Report tool, which provides PDF reports for of student performance across all tests in the semester, compared to the class average and listing all curricular categories for which the student score places them in the At-Risk performance band. Some embodiments of the present invention also report back a detailed analysis of student performance on each question in an assessment. In these reports, educators may see student performance per question, showing percentage of each answer marked in the case of multiple choice, and may sort questions by performance within each curricular category tested. In the instances of the present invention where paper answer sheets are used, the Assessment System may also provide a labeling feature, enabling teachers to print out sheets of labels that report per student overall score, questions missed, the correct answers, and any curricular categories for which the student has been deemed “At-Risk”.

INTEGRATION WITH CURRICULUM

In some instances of the present invention, the Student Assessment System provides educators with connections from the results of their assessments to instructional materials. Instructional materials are stored in the Instructional Databank, and are categorized by curricular categories. A single piece of instructional material may be categorized to several categories, and to different categorization schema. In particular, a lesson plan on fractions and decimals may be categorized to the curricular categories for fractions and decimals in the California State Standards, as well as those analogous categories in the Texas Essential Knowledge Standards.

The Assessment System's Instructional Data Bank is an open platform for categorizing instructional materials to curricular categories. Educators gain direct access to the resources in the Instructional Databank, and may view the resources and the curriculum categories that they cover. The Instructional Databank may include questions from textbooks as well as the sections of the textbook that address each particular curriculum category. In some instances of the present invention, the textbook sections and problems have been electronically loaded into the Instructional Databank and may be presented electronically to the user through the system. In other instances of the present invention the questions and sections are categorized in the system and the system acts as a reference, pointing the educator to the sections and questions within the textbook. The Instructional Databank may also include any instructional materials, and store them by curriculum categories. In particular, the Instructional Databank may store lesson plans, professional development videos (online and offline), related materials from books, related web sites and other online materials, district, school and teacher created resources, and any other offline or online educational resources. In each instance, these resources may either be stored electronically in the Instructional Databank, or the databank may store a reference to the materials which may be accessed outside of the databank.

The Assessment System may also use the results of the student performance data in the Data Warehouse to connect educators to instructional materials that are best suited to their students. For example, the Assessment System may suggest retesting students on particular curricular categories that they scored poorly on in the past, and it may recommend previously missed questions and new ones that cover the specific curricular categories. Prior art has categorized instructional materials to curricular categories, but in combination with the history of student data from the Data Warehouse, the Assessment System is unique in that it may:

Point educators to additional instructional materials to address areas of weakness for their students.

Create a review of areas of weakness for a class of students driven by their performance on past assessments

Create individual reviews of areas of weakness for each student in a class driven by their weak areas on past assessments

Provide instructional materials at the right level of difficulty to meet the capabilities of the students in question.

Automatically create curriculum pacing charts tailored to the student body to be taught and driven by the past performance of the class of students.

Recommend instructional materials to educators based upon how the materials have performed with students from a similar demographic.

All instructional materials, such as class or individualized reviews, that are generated from the Assessment System may draw from the entire array of instructional materials in the Instructional Databank. For example, a class review may include the questions most commonly missed by students on the past exam, additional questions from each of the curriculum categories covered by the frequently missed questions, the sections of the textbook that covered those curriculum categories, questions from the textbook on those categories, a lesson plan to reteach each of the categories, a professional development video for the teacher to study how to reteach the categories, and links to online resources on the various categories.

The above-described arrangements of systems and methods are merely illustrative of applications of the principles of this invention and many other embodiments and modifications may be made without departing from the spirit and scope of the invention as defined in the claims.

What is claimed is:

1. A method of providing educational assessment of at least one student using a computer network, the computer network comprising a central server and at least one remote terminal including an image scanner, the method comprising:
providing a test for subject matter;
providing an answer sheet for the test;
scanning a completed answer sheet with the image scanner;
grading answers on the scanned image of the answer sheet provided by the at least one student; and
automatically storing the results from the grading of the answer sheet in a central repository at the central server for the at least one student.

2. A method in accordance with claim 1 further comprising automatically flipping the scanned image of the answer sheet if it is upside down.

3. A method in accordance with claim 2 wherein the answer sheet includes at least one mark in at least one location and the scanned image of the answer sheet is automatically flipped if the at least one mark is in the wrong location after it is scanned.

4. A method in accordance with claim 1 wherein the answer sheet is printed on standard 8.5 inch by 11 inch paper.

5. A method in accordance with claim 1 wherein the answer sheet comprises one of a facsimile or a photocopy of an answer sheet.

6. A method in accordance with claim 1 wherein the answer sheet includes an identification icon that is read by the central server and provides all information for obtaining required information from a central repository at the central server for grading the answer sheet.

7. A method in accordance with claim 6 wherein the identification icon is comprised of one or more black boxes.

8. A method in accordance with claim 1 wherein if the identification information on the answer sheet can not be recognized in a central repository database, the remote terminal prompts the user through a computer interface for additional information to identify the answer sheet.

9. A method in accordance with claim 1 further comprising normalizing the scanned answer sheet before evaluating it.

10. A method in accordance with claim 9 wherein the normalizing comprises providing icons in multiple locations on the answer sheet and comparing the location of the icons on the scanned-in answer sheet with a reference answer sheet.

11. A method in accordance with claim 10 wherein the algorithm to compare locations of the multiple icons on the scanned-in answer sheet with a reference answer sheet is a 3×3 matrix transformation.

12. A method in accordance with claim 1 further comprising applying a software localization heuristic to identify the exact location of each mark on the answer sheet before evaluating it.

13. A method in accordance with claim 1 wherein the answer sheet includes information about a student and the method comprises automatically adding a student to a student roster at a central repository at the central server if the student isn't already included in the student roster.

14. A method of providing educational assessment of at least one student using a computer network, the computer network comprising a central server including a central repository and at least one remote terminal, the method comprising:
providing a test for subject matter;
providing a group of students in a roster in the central repository to whom to administer the test;
generating a single answer sheet uniquely identified for the particular test and the group of students; and
grading the answer sheet.

15. A method in accordance with claim 14 wherein the answer sheet is generated such that it is formatted to be printed on standard 8.5 inch by 11 inch paper.

16. A method in accordance with claim 15 wherein the answer sheet is generated in a Portable Document Format (PDF) format.

17. A method in accordance with claim 14 further comprising scanning in an answered answer sheet, and wherein the scanned answer sheet includes an identification icon that is read by the central server and provides all information for obtaining required information from a central repository at the central server for grading the answer sheet.

18. A method in accordance with claim 17 wherein the identification icon is comprised of one or more black boxes.

19. A method in accordance with claim 14 further comprising scanning in an answered answer sheet, and wherein the scanned answer sheet contains both an identification icon that identifies the group of students, and a list of all students in the group with a fill-in icon by each student's name; the combination of the identification icon and a filled-in icon by a student's name providing all information for obtaining required information from a central repository at the central server to identify the student taking the test.

20. A method in accordance with claim 19 wherein the scanned identification icon is comprised of one or more black boxes.

21. A method in accordance with claim 14 further comprising scanning in an answered answer sheet, and wherein the scanned answer sheet contains both an identification icon that identifies the group of students, and a list of all students in the group with a fill-in icon by each student's name; the combination of the identification icon and a filled-in icon by a student's name providing all information for obtaining required information from a central repository at the central server both to identify the student taking the test and for grading the answer sheet.

22. A method in accordance with claim 21 wherein the identification icon is comprised of one or more black boxes.

23. A method in accordance with claim 14 wherein all the information about the test required to generate the answer sheet is input through a computer interface without inputting the actual questions or answers on the test.

24. A method of providing educational assessment of at least one student using a computer network, the computer network comprising a central server and at least one remote terminal including an image scanner, the method comprising:
providing a test for subject matter;
providing a group of students in a roster in the central repository to whom to administer the test;
generating a single answer sheet uniquely identified for the particular test and the group of students;
scanning a completed answer sheet with the image scanner;
grading answers provided by the at least one student on the scanned image of the answer sheet; and
automatically storing the results from the grading of the answer sheet in a central repository at the central server for the at least one student.

25. A method in accordance with claim 24 further comprising automatically flipping the scanned image of the answer sheet if it is upside down; the answer sheet includes at least one mark in at least one location and the scanned image of the answer sheet is automatically flipped if the at least one mark is in the wrong location after it is scanned.

26. A method in accordance with claim 24 wherein the answer sheet is generated such that it is formatted to be printed on standard 8.5 inch by 11 inch paper.

27. A method in accordance with claim 24 wherein the answer sheet comprises one of a facsimile or a photocopy of an answer sheet.

28. A method in accordance with claim 24 further comprising normalizing the scanned answer sheet before evaluating it, the normalizing comprised of providing icons in multiple locations on the answer sheet and comparing the location of the icons on the scanned-in answer sheet with a reference answer sheet.

29. A method in accordance with claim 24 wherein all the information about the test required to generate the answer sheet is input through a computer interface without inputting the actual questions or answers on the test.

30. A method in accordance with claim 24 wherein the answer sheet contains both an identification icon that identifies the group of students, and a list of all students in the group with a fill-in icon by each student's name; the combination of the identification icon and a filled-in icon by a student's name providing all information for obtaining required information from a central repository at the central server both to identify the student taking the test and for grading the answer sheet.

31. A method in accordance with claim 30 wherein if the identification information on the answer sheet may not be recognized in the central repository database, the remote terminal prompts the user through a computer interface for additional information to identify the answer sheet.

32. A method in accordance with claim 30 wherein the central repository at the central server consists of at least one of the following data pertaining to the student group taking the test: roster data from a school district student information system, demographic data, prior student test data.

33. A method in accordance with claim 32 further comprising automatically associating all new scores calculated during the grading of a student's answer sheet with previous data about the student contained within the central repository.

34. A method in accordance with claim 33 wherein the answer sheet is generated such that it is formatted to be printed on standard 8.5 inch by 11 inch paper, and it contains an identification icon comprised of one or more black boxes.

35. A method of providing educational assessment of at least one student using a computer network, the computer network comprising a central server and at least one remote terminal, the method comprising:
providing a student group to assess;
providing curricular categories to be assessed;
automatically obtaining questions and answers related to the curricular categories from a central repository at the central server based upon past performance of the at least one student within the curricular categories;
providing an interface to manually select additional questions and answers;
automatically generating a test with the questions and answers;
automatically generating an answer platform;
evaluating answers provided by the at least one student on the answer platform; and
automatically storing results from the evaluation in the repository for the at least one student.

36. A method in accordance with claim 35 further comprising uploading at least one question and corresponding answer from an offline source.

37. A method in accordance with claim 35 further comprising typing into a computer interface at least one question and corresponding answer.

38. A method in accordance with claim 35 wherein educational assessment is provided for multiple students, and questions and answers are obtained for each student's test based upon that student's past performance within the determined subject matter.

39. A method in accordance with claim 35 wherein educational assessment is provided for multiple students, and questions and answers are obtained for each student's test based upon all students' collective past performance within the determined subject matter.

40. A method in accordance with claim 39 wherein questions and answers are automatically obtained in the curricular categories on which students performed most poorly, as determined by all students' collective performance on the prior assessments stored in the central repository.

41. A method in accordance with claim 39 wherein questions and answers are automatically obtained that were most commonly missed by the student group on prior assessments in the central repository.

42. A method in accordance with claim 39 wherein the answer platform comprises answer sheets, and the method further comprises scanning completed answer sheets with an image scanner, grading the scanned images of the answer sheets, and storing the results in the central repository.

43. A method in accordance with claim 42 wherein each answer sheet contains both an identification icon that identifies the group of students, and a list of all students in the group with a fill-in icon by each student's name; the combination of the identification icon and a filled-in icon by a student's name providing all information for obtaining required information from a central repository at the central server both to identify the student taking the test and for grading the answer sheets.

44. A method in accordance with claim 39 further comprising creating at least one of a new test, a review sheet, a lesson plan, and a homework assignment based upon evaluating the graded answer platform.

45. A method in accordance with claim 44 wherein what is created is created for individual students.

46. A method in accordance with claim 44 wherein what is created is created for a group of students.

47. A system for providing educational assessment of at least one student, the system comprising:
a central server including a central repository, the central repository including student information from a school district student information system and a plurality of questions and corresponding answers for a variety of subject matters, the questions and answers being organized based upon at least subjects within subject matters; and
at least one remote terminal, the remote terminal being coupled with the central server via a communication conduit;
at least one remote scanner in communication within the remote terminal;
wherein tests and corresponding answer platforms are automatically generated by the central server based upon the student information and desired subject matter.

48. A system in accordance with claim 47 wherein an answered answer platform is evaluated by the central server.

49. A system in accordance with claim 48 wherein at least one of a new test, a study assignment and a review sheet are created by the central server based upon evaluating the answers.

50. A method of providing educational assessment of at least one student using a computer network, the computer network comprising a central server and at least one remote terminal, the method comprising:
providing the central repository contains performance data from prior assessments organized by curricular categories for the at least one student;
providing a selection of curricular categories;
providing the number of curricular categories to review;
providing the number of questions and answers per curricular category to assign;
generating an individualized homework assignment for each of the students, comprising:
questions from prior tests in the central repository that the student missed in the curricular categories for which they performed the most poorly;
additional questions in each of the curricular categories randomly drawn from the central repository that, when added to the number of questions missed from prior tests total the number of questions assigned per curricular category;
instructional resources categorized to the curricular categories for which the student performed the most poorly.

51. A method in accordance with claim 50 wherein the instructional resources in the homework are pointers to offline resources

52. A method in accordance with claim 51 wherein the offline resources are at least one of textbook pages, textbook problems, and lesson plans.
